(19) United States
(12) Patent Application Publication
(10) Pub. No.: US 2008/0022215 A1
(43) Pub. Date: Jan. 24, 2008

(54) APPARATUS, SYSTEM, AND METHOD FOR EXPANDING AND COLLAPSING A LIST IN A DIAGRAM ENVIRONMENT

(76) Inventors: Robert Lee, San Jose, CA (US); Danny Nguyen, San Jose, CA (US)

Correspondence Address: Kunzler & McKenzie, 8 EAST BROADWAY, SUITE 600, SALT LAKE CITY, UT, 84111, US

(21) Appl. No.: 11/459,292

(22) Filed: Jul. 21, 2006

(51) Int. Cl. G06F 9/00; G06F 3/00

(52) U.S. Cl. 715/762; 715/764; 715/810; 715/835

(57) ABSTRACT

An apparatus, system, and method are disclosed to expand and collapse a GUI list component. The apparatus may have a display module, a user interface module, a default module, a resize module, a selection module, a collapse module, an expand module, and a scroll module. The display module displays a GUI list component to a user with a list frame and list entries. The user interface module receives user inputs. The default module sets dimensions of the list frame based on default values. The resize module sets dimensions of the list frame based on the user inputs. The selection module defines pervasive list entries and non-pervasive list entries. The collapse module hides the non-pervasive list entries without hiding the pervasive list entries, and resizes the list frame. The expand module reveals the non-pervasive list entries and resizes the list frame. The scroll module dynamically displays a scroll component.

### BACKGROUND OF THE INVENTION

1. Field of the Invention

This invention relates to expanding and collapsing a list and more particularly relates to expanding and collapsing a Graphical User Interface list component in a diagram environment.

2. Description of the Related Art

Lists are frequently used in diagram environments, such as computer graphical user interfaces (GUIs) or computer workspaces. Lists are used for menus and other user selections, and to represent data from databases and other computer programs. Often, a user requires only a subset of a list, and not the entire list, to make the desired selection, or to see the relevant data. Because lists are often larger than the subset of the list entries required by the user, unnecessary space in the diagram environment is taken up by the list, and the user must also search through unnecessary list entries in order to find the desired list entries, wasting time and effort.

Current methods for collapsing and expanding lists in a diagram environment depend on data hierarchies, hard coded non-customizable selections, or usage statistics to determine which list entries to display. Many lists are not hierarchical, and hard coded non-customizable selections or usage statistics often do not reflect the actual subset of the list that is required by the user.

From the foregoing discussion, it should be apparent that a need exists for an apparatus, system, and method that expands and collapses a list based on user input. Beneficially, such an apparatus, system, and method would optimize the space occupied by the list in the diagram environment, simplify the list for the user, and decrease the time spent by the user finding data or making selections.

### SUMMARY OF THE INVENTION

The present invention has been developed in response to the present state of the art, and in particular, in response to the problems and needs in the art that have not yet been fully solved by currently available floating list expanding and collapsing methods. Accordingly, the present invention has been developed to provide an apparatus, system, and method for expanding and collapsing a floating list in a diagram environment that overcome many or all of the above-discussed shortcomings in the art.

The apparatus to expand and collapse a list is provided with a plurality of modules configured to functionally execute the necessary steps of expanding and collapsing the list. These modules in the described embodiments include a display module, a user interface module, a default module, a resize module, a selection module, a collapse module, an expand module, and a scroll module.

The display module, in one embodiment, is configured to display a GUI list component to a user. The GUI list component comprises a list frame and one or more list entries. In one embodiment, the user interface module receives one or more user inputs.

In a further embodiment, the default module sets one or more dimensions of the list frame based on one or more default values. In another embodiment, the resize module sets one or more dimensions of the list frame based on the user inputs.

In one embodiment, the selection module defines one or more of the list entries as pervasive list entries, and the remainder of the list entries as non-pervasive list entries. In a further embodiment, the selection module makes the definitions based on a selection criteria selected from the group consisting of dynamic user selection, a predefined condition, and a user defined condition.

In another embodiment, the collapse module hides the non-pervasive list entries in the GUI list component without hiding the pervasive list entries, and resizes the list frame in response to user activation of a view control. In a further embodiment, the expand module reveals the non-pervasive list entries in the GUI list component and resizes the list frame in response to user activation of a view control. In one embodiment, the scroll module dynamically displays a scroll component to scroll through the list entries in the GUI list component in response to the user inputs. A computer program product of the present invention is also presented for expanding and collapsing a floating list. The operations of the computer program product in the disclosed embodiments substantially include the steps necessary to carry out the functions presented above with respect to the operation of the described apparatus.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a listing apparatus in accordance with the present invention; and

FIG. 2 is a screenshot diagram illustrating one embodiment of an expandable and collapsible GUI list component in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of generating a signal, causing a signal to be generated, or causing execution of a program of machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

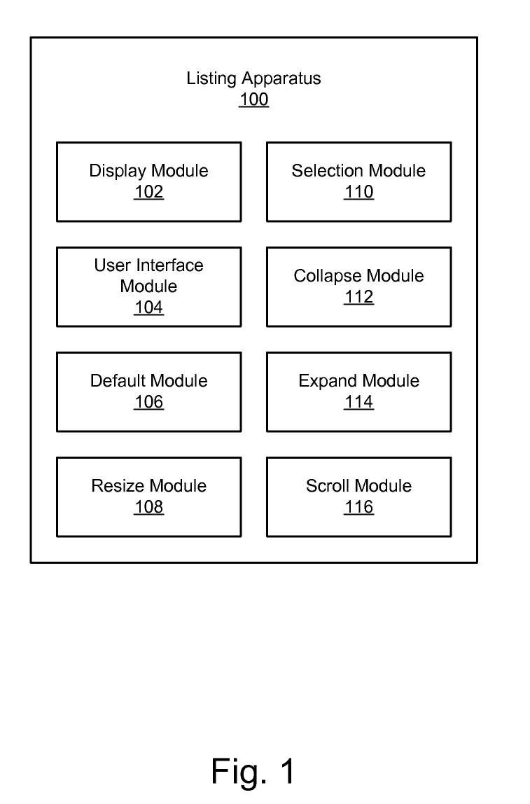

FIG. 1 is a schematic block diagram illustrating one embodiment of a listing apparatus 100 in accordance with the present invention. In one embodiment, the listing apparatus 100 comprises a display module 102, a user interface module 104, a default module 106, a resize module 108, a selection module 110, a collapse module 112, an expand module 114, and a scroll module 116.

In one embodiment, the display module 102 displays a GUI list component to a user. The display module may be a computer display, such as a cathode ray tube (CRT) display, liquid crystal display (LCD), or organic light emitting diode (OLED) display, a television, a projector, a portable display on an electronic device, or another display capable of displaying a GUI list component. The display module may display an entire diagram environment or GUI, a portion thereof, or just the GUI list component. The GUI list component may be movable based on a user input, may appear or disappear based on user input, or may be statically positioned within the GUI diagram environment. In one embodiment, the GUI list component has a list frame and one or more list entries. The list frame may substantially circumscribe the GUI list component, and may be user customizable, providing a tool for the user to resize or move the GUI list component. The list entries may comprise a user menu configured to receive user input, or a list of data relevant to the user. Examples of user data are database records, database field names, program data, file lists, media playlists, contact lists, and the like. The list entries may be listed vertically, horizontally, or in a combination of the two, for example, a table.

In one embodiment, the user interface module 104 receives one or more user inputs. The user interface module may be a keyboard, a mouse, a touch screen, a microphone, a click-wheel, one or more buttons, a dial, a switch, a camera, a sensor, or another user interface capable of receiving inputs from a user. In a further embodiment, the one or more inputs are a series of consecutive inputs. In another embodiment, the one or more inputs are separated by a possibly substantial amount of time, for example one or more initial setup inputs, and one or more runtime inputs that may be hours, days, or weeks later.

In one embodiment, the default module 106 sets one or more dimensions of the list frame based on one or more default values. The default values may be predefined in computer program code or a computer data file, or may be defined as default values by a user. In one embodiment, the default values are the dimensions of the list frame and the GUI list component when first displayed.

In one embodiment, the resize module 108 sets one or more dimensions of the list frame based on the user inputs. The inputs, as described above, are received from the user interface module 104. In one embodiment, the inputs are received from a mouse, and may included dragging the list frame to define the one or more dimensions. In another embodiment, the inputs may be a mouse click on a button or area included in the list frame that denotes one or more preset dimensions. One of the preset dimensions may be the default dimensions described above. In a further embodiment, the inputs may be keyboard strokes defining the dimensions in a standard unit of measurement, such as pixels, inches, centimeters and the like. The inputs may also be a combination of mouse clicks and keyboard entries, or other inputs as described above, for example a mouse selection of a resize button or menu item, and keyboard entries denoting the desired dimensions.

In one embodiment, the selection module 110 defines one or more of the list entries as pervasive list entries, and the remainder of the list entries as non-pervasive list entries. A pervasive list entry is a list entry that remains visible in the GUI list component when the collapse module 112 collapses the GUI list component, as described below. A non-pervasive list entry is a list entry that the collapse module 112 hides in the GUI list component when the collapse module 112 collapses the GUI list component, as described below.

The selection module 110 may define the list entries as pervasive list entries or non-pervasive list entries based on rules or definitions defined in computer program code or stored in a computer data file, based on established criteria or categories, based on the user inputs, or in another manner. For example, if the list entries are database fields, the key fields could be defined as pervasive list entries, while the remaining fields would be defined as non-pervasive list entries. A computer programmer may specify in program code or in a data file that the key fields are pervasive list entries, or a user may specify that the key fields are pervasive list entries. In a further embodiment, a user may override established or predefined pervasive list entry selections with user defined pervasive list entry selections.

In one embodiment, the selection module 110 defines the list entries as pervasive list entries or non-pervasive list entries based on the user inputs. The inputs may comprise a user selection of individual list entries, of categories, of criteria, or the like, that may be used to define one or more list entries as pervasive list entries. The GUI list component may have graphical aspects that facilitate the selection of list elements by the user, for instance check boxes, radio buttons, a menu, a dialogue, or other graphical tools. The list entries defined by the selection module 110 as pervasive list entries need not be contiguous, or based on list entry hierarchies. User selection of pervasive or non-pervasive list entries may also override default or predefined selections, or in a further embodiment, there may be no entries defined as pervasive list entries prior to the user selection.

In one embodiment, the collapse module 112 hides the non-pervasive list entries in the GUI list component and resizes the list frame and the GUI list component in response to the user inputs. As described above, the inputs may be from one or more of a plurality of user interface devices. In one embodiment, the one or more inputs comprise a user activation of a view control. The user activation of the view control may be a click on a graphical bar, arrow, or similar representation coupled to the bottom of the list frame, or some user activation of another view control elsewhere on the GUI list component. The use of an arrow may represent the direction in which the GUI list component will be resized, or collapsed.

By hiding the one or more non-pervasive list entries in the GUI list component, the collapse module 112 shortens the length of the list. In one embodiment, the collapse module 112 resizes the list frame to reflect the size of the shortened list. In another embodiment, the collapse module 112 resizes the list frame according to a predefined size. The predefined size may be a default collapsed size defined in computer program code or a computer data file, a size configured by the user, or the last collapsed size. In one embodiment, the resize module 108 can resize the GUI list component in a direction perpendicular to the list after the collapse module 112 has resized the GUI list component, ie. in a horizontal direction for a vertical list, but not in a direction parallel to the list, ie. in a vertical direction for a vertical list. In another embodiment, when the default collapsed size is smaller than the size of the shortened list, the scroll module 116 may be used to dynamically display a scroll component to scroll through the list entries that are not visible in the resized GUI list component, as described below.

In one embodiment, the expand module 114 reveals the non-pervasive list entries in the GUI list component and resizes the list frame in response to the user inputs. In one embodiment, the inputs may be substantially similar to those described above with reference to the collapse module 112, including user activation of a view control. The user activation of a view control may comprise a user click on a graphical bar, arrow, or similar representation coupled to the bottom of the list frame. The use of an arrow may represent the direction in which the GUI list component will be resized, or expanded. In one embodiment, the expand module 114 resizes the list frame to a size that includes the list entries. In a further embodiment, the expand module 114 resizes the list frame to a predefined size. The predefined size may be the same size that the list frame occupied before it was collapsed by the collapse module 112, a default collapsed size defined in computer program code or a computer data file, or a size configured by the user. When the size of the expanded list is larger than the size of the resized list frame, the scroll module 116 may be employed as described below.

In one embodiment, the scroll module 116 dynamically displays a scroll component to scroll through the list entries in the GUI list component in response to the user inputs. The scroll module 116 may display a scroll bar, arrows, or other graphical tool to facilitate the receiving of scrolling inputs from a mouse, or alternatively may receive keyboard, scroll-wheel, or other inputs comprising a scroll command and a scroll direction. In one embodiment, the scroll module 116 dynamically displays a graphical scrolling tool or scroll component when the size of the list entries exceeds the size of the list frame. In another embodiment, the scroll module 116 may scroll both vertically and horizontally, and may display a scroll bar, arrows, or other graphical tool in both the horizontal and vertical directions. In a further embodiment, the scroll module 116 may receive inputs configured to “grab” the list with a cursor or mouse and scroll the list in any two dimensional direction, meaning in any direction within the plane of the diagram environment.

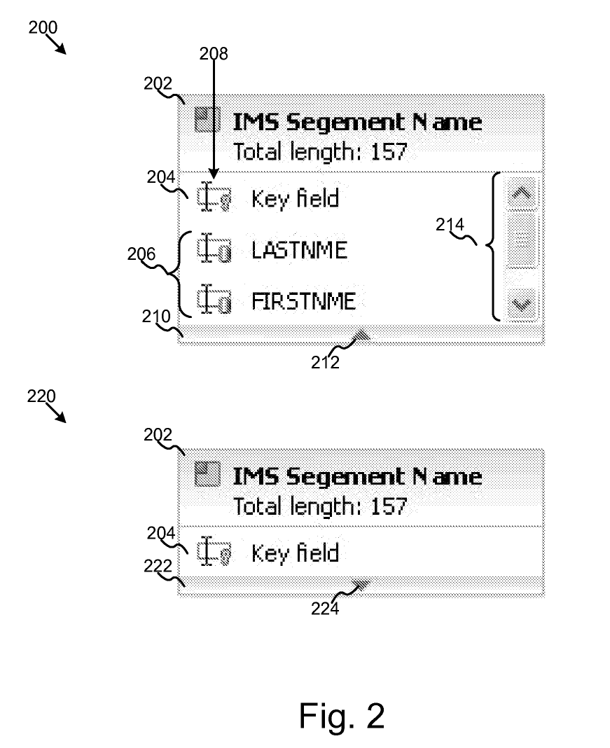

FIG. 2 is a screenshot diagram illustrating one embodiment of an expanded GUI list component 200 and a collapsed GUI list component 220. The expanded GUI list component 200 and the collapsed GUI list component 220 may be substantially similar to the GUI list component that the display module 102 displays to the user as described above. In one embodiment, the GUI list components 200, 220 each have a list frame 202 and one or more list entries 204, 206.

The list frame 202 substantially circumscribes the expanded GUI list component 200 and the collapsed GUI list component 220. The list frame 202 may be a visible graphical component of the GUI list component diagram, similar to the darker colored list frame 202, or may be a non-visible frame defined by the perimeter of the GUI list component. In one embodiment, the list frame 202 is thicker at the top to display a title and other list data, such as a list length statistic. The list frame 202 may have one of a plurality of shapes or thicknesses that substantially circumscribe the GUI list component 200, 220. In one embodiment, the user may resize the GUI list component 200 by selecting or “grabbing” and dragging an edge or corner of the list frame 202. The list frame 202 may also include a button which may be clicked or selected to return the GUI list component 200 and the list frame 202 to a previous or default size.

In one embodiment, the list entries 204, 206 represent the names of database fields. The selection module 110 defined the key field list entry 204 as a pervasive list entry, and the other list entries 206 as non-pervasive list entries. As described above, the selection module 110 may make such definitions based on user input into a menu or dialogue associated with the GUI list component 200, or according to predefined criteria or definitions. In one embodiment, the pervasive key field list entry 204 was selected individually and dynamically to be defined as a pervasive list entry. In another embodiment, the pervasive key field list entry 204 was selected as a group or category, such as “key database fields.” In a further embodiment, the expanded GUI list component 200 also includes a graphical diagram 208 for each of the list entries 204, 206. The graphical diagram 208 may denote whether a list entry is pervasive or non-pervasive, may represent a category that the list entry belongs to, may be a user selectable tool configured to display additional information about the list entry, or may be a user selectable tool configured to allow the user to edit the list entry when selected, clicked, or the like.

In one embodiment, the list frame 202 may also include a collapse bar 210, and an arrow 212, or similar representation, coupled to the bottom of the list frame 202, as described above. In one embodiment, the collapse bar 210 may be a view control as described above. The arrow 212 points upwards, signifying that when the collapse bar 210 is clicked or selected, or another collapse input is given, that the GUI list component 200 will collapse vertically upwards to include only the pervasive list entry 204. The form of the list after the collapse bar 210 has been clicked, selected, or the like may be substantially similar to that of the collapsed GUI list component 202. In a further embodiment, the GUI list component 200 includes a scroll bar 214 to assist the user in sending scrolling inputs to the scroll module 116 in order to view additional list entries that are not viewable in the GUI list component 202.

The list frame 202 of the collapsed GUI list component 220 has been resized or collapsed to include only the pervasive list entry 204. The non-pervasive list entries 206 are hidden in the collapsed GUI list component 220. Although the expand bar 222 is similar to the collapse bar 210 in appearance, the arrow 224 points downward, in an opposite direction as the arrow 212 of the expanded GUI list component 202. The downward arrow signifies that when the expand bar 224 is clicked or selected, or another expand input is given, that the GUI list component 220 will expand vertically downwards to a previous size or a default size, which may be substantially similar to the expanded GUI list component 200. In one embodiment, the expand bar 222 may comprise a view control, as described above.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to expand and collapse a graphical user interface (GUI) list: component, the apparatus comprising:
a display module configured to display a GUI list component to a user, the GUI list component comprising a list frame and one or more list entries;
a user interface module configured to receive one or more user inputs;
a default module configured to set one or more dimensions of the list frame based on one or more default values;
a resize module configured to set one or more dimensions of the list frame based on the user inputs;
a selection module configured to define one or more of the list entries as pervasive list entries, and the remainder of the list entries as non-pervasive list entries;
a collapse module configured to hide the non-pervasive list entries in the GUI list component without hiding the pervasive list entries, and to resize the list frame in response to user activation of a view control;
an expand module configured to reveal the non-pervasive list entries in the GUI list component and to resize the list frame in response to user activation of a view control; and
a scroll module configured to dynamically display a scroll component and to scroll through the list entries in the GUI list component in response to the user inputs.

2. The apparatus of claim 1, wherein the selection module defines one or more list entries as pervasive list entries based on a selection criteria selected from the group consisting of dynamic user selection, a predefined condition, and a user defined condition.

3. A computer program product comprising a computer readable medium having computer usable program code programmed for expanding and collapsing a GUI list component, the operations of the computer program product comprising:
displaying a GUI list component to a user, the GUI list component comprising of a list frame and one or more list entries;
defining one or more of the list entries as pervasive list entries, and the remainder of the list entries as non-pervasive list entries;
receiving one or more inputs from the user;
setting one or more dimensions of the list frame based on the inputs;
hiding the non-pervasive list entries in the GUI list component without hiding the pervasive list entries, and resizing the list frame in response to user activation of a view control; and
revealing the non-pervasive list entries to the GUI list component and resizing the list frame in response to user activation of a view control; and
scrolling through the list entries in the GUI list component in response to the inputs.

4. The computer program product of claim 3, wherein the one or more list entries are defined as pervasive list entries based on a selection criteria selected from the group consisting of dynamic user selection, a predefined condition, and a user defined condition.

5. The computer program product of claim 3, wherein further comprising setting one or more dimensions of the list frame based on one or more default values.
